(19) United States
(12) Patent Application Publication
(10) Pub. No.: US 2026/0171696 A1
(43) Pub. Date: Jun. 18, 2026

(54) CIRCUIT BOARD STRUCTURE OF ELECTRICAL CONNECTOR

(71) Applicant: V-General Technology Co., Ltd., Taoyuan City (TW)

(72) Inventors: Po-Wen YEH, Taoyuan City (TW); Tzu-Wei YEH, Taoyuan City (TW); Yu-Lun YEH, Taoyuan City (TW); Chien-Yeh LEE, Taoyuan City (TW)

(21) Appl. No.: 18/983,379

(22) Filed: Dec. 17, 2024

(51) Int. Cl. H01R 12/70; H01R 12/71; H01R 13/6594

(52) U.S. Cl. CPC H01R 12/707; H01R 12/714; H01R 12/716; H01R 13/6594

(57) ABSTRACT

A circuit board structure of an electrical connector is provided, including a circuit board body, fixing sections, a signal transmission portion complying a communication transmission protocol of one of USB-A, USB-B, USB-C, HDMI, and DP, a conducting portion, and a combining portion. The fixing sections, the signal transmission portion, the conducting portion, and the combining portion are arranged on the circuit board body. The fixing sections receive insertion pins of an electrical connector to insert therein. The signal transmission portion receives soldering portions of the electrical connector to combine therewith. The conducting portion is arranged in an area jointly enclosed by the signal transmission portion and each of the fixing sections. The combining portion functions to fix and combine the circuit board body with a bottom surface of the electrical connector. The contact between the bottom surface of the electrical connector and the conducting portion increases a noise draining path.

### BACKGROUND OF THE INVENTION

### (a) Technical Field of the Invention

The present invention relates to a circuit board structure of an electrical connector that enhances the performance of noise draining of the electrical connector, and also effectively reduce electromagnetic interference and radio frequency interference, and further effectively enhance fixing capability of the electrical connector.

### (b) Description of the Prior Art

Due to the rapid development of the technology and communication industry, everyone in modern times is no longer limited to geographical boundaries, but can interact more closely with each other and exchange a large amount of information and knowledge. To achieve the above-mentioned optimal state, electrical connectors and circuit boards connected to them are of vital importance. Especially, the transmission speed and functions today are becoming more and more powerful, which also improves the convenience of information transmission. Examples are USB-A, USB-B, and USB-C.

Furthermore, today is in the next-generation technology and has special requirements for transmission speed in order to effectively handle increasingly large files in terms of transmission. Especially in the audio and video section, HDMI or DP connectors are most commonly used to transmit 2K, 4K, 6K or even 8K images.

Although the above-mentioned various connectors have improved the convenience of information transmission, they also suffer instability in high-frequency transmission characteristics resulting from electromagnetic interference (EMI) and radio frequency interference (RFI). Although some manufacturers use mutual connection between shielding housings of male form and female form to increase the noise draining capability, the actual effect is very limited. Not only that, the electrical connector is also prone to detaching from the circuit board body when plugged in and out for a long time. The main reason is that the user often makes up and down shaking during the course of plugging and unplugging, and this may readily make the electrical connector separating from the circuit board body, or the shielding housing deformed or broken.

### SUMMARY OF THE INVENTION

The primary objective of the present invention is to provide an arrangement of conducting portion to increase the noise draining capability, effectively reduce electromagnetic interference (EMI) and radio frequency interference (RFI), and better the high-frequency characteristics, and also to effectively avoid the electrical connector being detached from the circuit board body or the shielding housing being deformed or broken resulting from improper plugging and unplugging in a long time.

The structure that the present invention adopts to achieve the above-described primary objective comprises a circuit board body. The circuit board body is provided with a plurality of fixing sections for receiving insertion pins of an electrical connector of USB-A, USB-B, USB-C, HDMI, or DP to insert therein, a signal transmission portion located at one side of each of the fixing sections for receiving soldering portions of the electrical connector to combine therewith, at least one conducting portion arranged in an area jointly enclosed by the signal transmission portion and each of the fixing sections, and at least one combining portion arranged on the conducting portion or at one side of the conducting portion, wherein the signal transmission portion complies the communication transmission protocol of USB-A, USB-B, USB-C, HDMI, or DP. Further, the conducting portion is primarily provided for receiving the bottom surface of the electrical connector to contact therewith to conduct out and drain noises. The combining portion is provided for connecting and fixing the circuit board body to the bottom surface of the electrical connector.

Thus, when the electrical connector is mounted to the circuit board body, the insertion pins of the electrical connector are connected with the fixing sections of the circuit board body, and the bottom surface of the electrical connector is set in contact engagement with the conducting portion. Further, the operation can be performed by using the combining portion to fix and combine the electrical connector with the circuit board body, and the combination can be fulfilled through soldering. As such, noise generated by the transmission conductors of the electrical connector can be quickly conducted out and drained through the shielding housing and the conducting portion, and thus, the high-frequency characteristics of the transmission conductors can be bettered and electromagnetic interference (EMI) and radio frequency interference (RFI) can be effectively reduced, and further, the electrical connector detaching from the circuit board body or the shielding housing deforming or breaking resulting from improper plugging and unplugging in a long time can be avoided.

Through the above technology, it is possible to overcome the problems existing in various conventional connectors and achieve the practical and progressive advantages of the present invention as mentioned above.

### BRIEF DESCRIPTION OF THE DRAWINGS

FIG. 1 is a perspective view of a first embodiment.

FIG. 2 is a schematic view showing implementation of the first embodiment.

FIG. 3 is a front view of the first embodiment.

FIG. 4 is a schematic view showing implementation of a second embodiment.

FIG. 5 is a schematic view showing implementation of a third embodiment.

FIG. 6 is a schematic view showing implementation of a fourth embodiment.

FIG. 7 is a schematic view showing implementation of a fifth embodiment.

FIG. 8 is a schematic view showing a signal transmission portion of a sixth embodiment.

FIG. 9 is a schematic view showing a signal transmission portion of a seventh embodiment.

FIG. 10 is a schematic view showing implementation of an eighth embodiment.

FIG. 11 is a schematic view showing implementation of a ninth embodiment.

FIG. 12 is a schematic view showing implementation of a tenth embodiment.

FIG. 13 is a schematic view showing implementation of an eleventh embodiment.

### DETAILED DESCRIPTION OF THE PREFERRED EMBODIMENTS

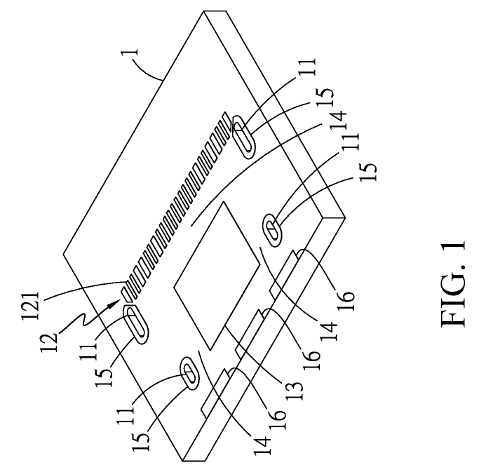

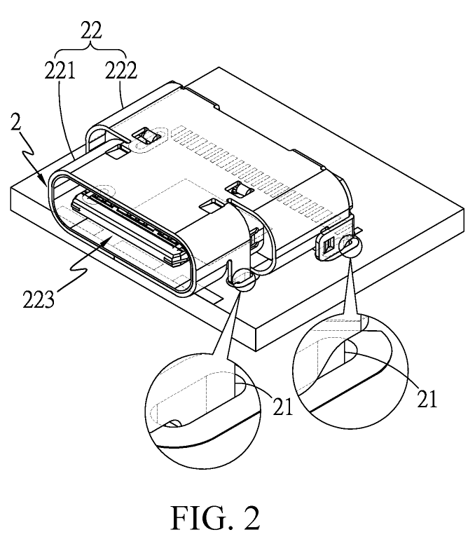

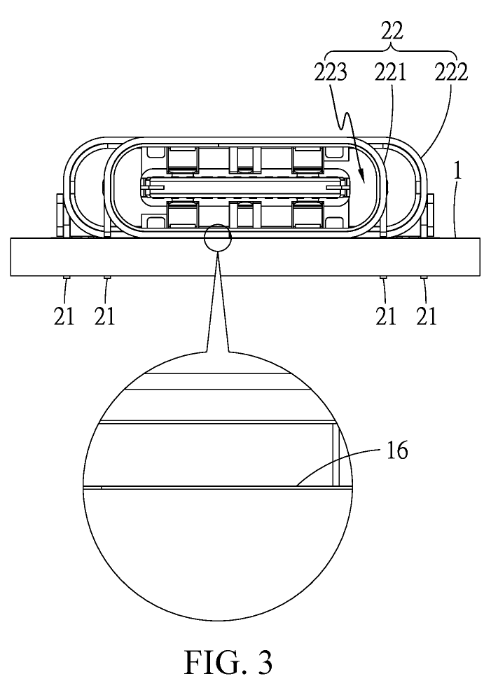

Referring to FIGS. 1-3, the present invention comprises:

a circuit board body 1;

a plurality of fixing sections 11, which are arranged on the circuit board body 1 for receiving insertion of insertion pins 21 of an electrical connector 2 therein;

a signal transmission portion 12, which complies a communication transmission protocol of one of USB-A, USB-B, USB-C, HDMI, and DP and is arranged on the circuit board body 1 and located at one side of each of the fixing sections 11 for receiving soldering portions of the electrical connector 2 to combine therewith by means of surface mount technology (SMT);

at least one conducting portion 13, which is arranged in an area jointly enclosed by the signal transmission portion 12 and each of the fixing sections 11 for receiving a bottom surface of the electrical connector 2 to contact therewith in order to conduct out and drain noises; and

at least one combining portion 16, which is arranged on the conducting portion 13 or at one side of the conducting portion 13 for connecting and fixing the circuit board body 1 to the bottom surface of the electrical connector 2.

In the instant embodiment, as an example, the conducting portion 13 is arranged between each of the fixing sections 11.

In the instant embodiment, an insulation region 14 is arranged between the conducting portion 13 and the signal transmission portion 12 and each of the fixing sections 11.

In the instant embodiment, as an example, the signal transmission portion 12 comprises 26 conductors 121, which are arranged in a single row so as to achieve an advantage of fast manufacturing by utilizing single-row surface mounting.

In the instant embodiment, as an example, a plurality of combining portions 16 are adopted.

In the instant embodiment, the conducting portion 13 and the combining portion 16 comprises conductive copper materials.

In the instant embodiment, as an example, the signal transmission portion 12 is made for USB-C.

It can be appreciated from the above that in the implementation of the present invention, the insertion pins 21 uses the electrical connector 2 to insert into and connect with the fixing sections 11 and also uses the combining portion 16 to fix the electrical connector 2 to the circuit board body 1. After the operation is completed, the bottom surface of the shielding housing 22 of the electrical connector 2 is laid flat on the conducting portion 13, so that in addition to fixing fulfilled with the fixing sections 11, the electrical connector 2 also uses the combining portion 16 to securely fix the electrical connector 2 in position. In the instant embodiment, the combining portion 16 is arranged on an edge of the circuit board body 1 and is located close to the opening 223 of the electrical connector 2, so that during insertion and removal of the electrical connector 2 by a user, the opening 223, which is the portion that is most prone to shaking, is fixed by the combining portion 16, and thus, the opening 223 is securely kept in position without easily causing separation of the insertion pins 21 from the circuit board body 1. Particularly when the electrical connector 2 is USB-C, as a bridging and connecting structure between the front section 221 and the rear section 222 of the shielding housing 22 is relatively weak, it can be deformed or broken resulting from unlimited abnormal up-and-down shakes, and the present invention is made to overcome such a problem by using the combining portion 16 to combine, through soldering, with an under side of the front section 221, so as to fix, through soldering, the source site where shaking occurs to thereby avoid shaking occurring on the front section 221 and thus enhancing the durability of the bridging and connecting structure between the front section 221 and the rear section 222.

Further, in addition to contact with a conductive copper zone 15 arranged on a periphery of each of d the fixing sections 11, the underside of the electrical connector 2 also increases a noise draining path for the shielding housing 22 by means of the conducting portion 13. In other words, increasing the contact area between the shielding housing 22 and the conducting portion 13 (which comprises a conductive copper material) allows noises to be transmitted to the outside of the shielding housing 22 in a faster way, making the noises generated by the transmission conductors of the electrical connector 2 fast draining out through the shielding housing 22 and the conducting portion 13, and as such, the high-frequency characteristics of the transmission conductors of the electrical connector 2 is bettered, and electromagnetic interference (EMI) and radio frequency interference (RFI) are reduced.

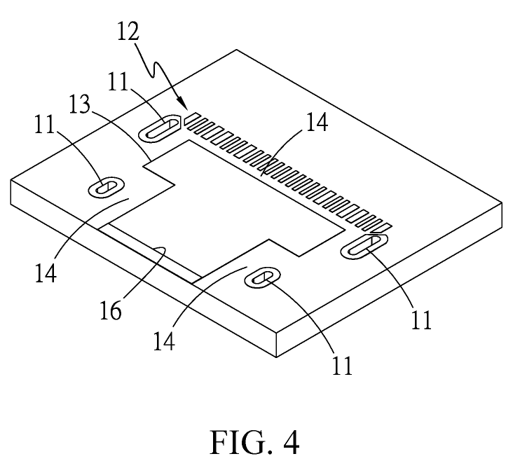

Referring to FIG. 4, an insulation region 14 is arranged between the conducting portion 13 and the signal transmission portion 12 and each of the fixing sections 11, and the instant embodiment is different from the previous embodiment in that in the instant embodiment, the combining portion 16 being a single one is taken as an example, and the conducting portion 13 is of a T-shape. By means of the arrangement of the T-shaped conducting portion 13, in addition to contact made with the front section of the shielding housing, contact can also be made with the rear section, so as to make the path for draining noise from the shielding housing even larger for even faster draining the noses to the outside.

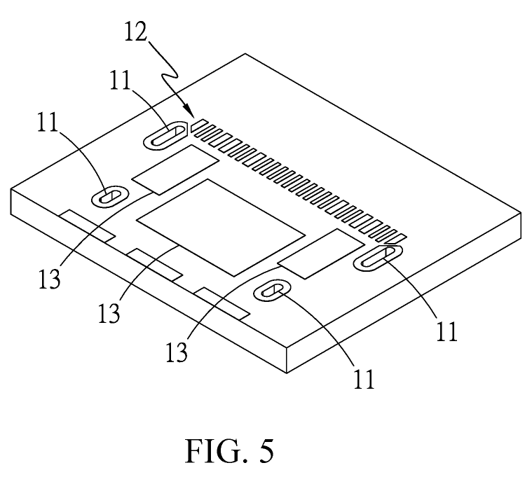

Referring to FIG. 5, in the instant embodiment, the conducting portion 13 being composed of multiple ones is taken as an example, all being arranged in the area jointly enclosed by the signal transmission portion 12 and each of the fixing sections 11, and this shows that the number of the conducting portions 13 is not constrained in the present invention.

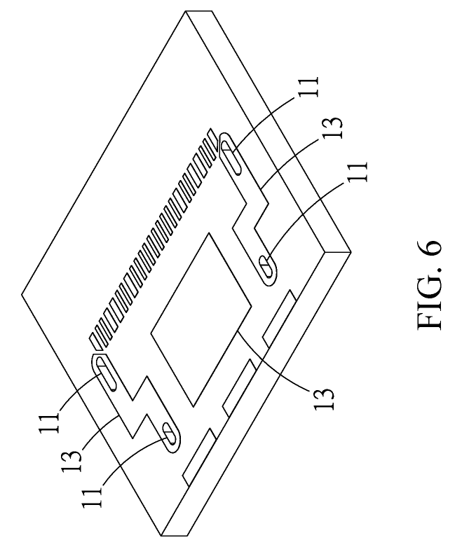

Referring to FIG. 6, in the instant embodiment, the conducting portions 13 are located between each of the fixing sections 11, and the conducting portions 13 include or are combined with the conductive copper zones on the peripheries of the fixing sections 11 to show a configuration that is close to an N-shape. Of course, this arrangement is provided only as an example for illustration. In case that the fixing sections 11 are arranged in a straight line, rather than being arranged in a staggered manner, the conducting portion 13 shows a linear form. This shows that the arrangement of the conducting portion 13 is not constrained in the present invention.

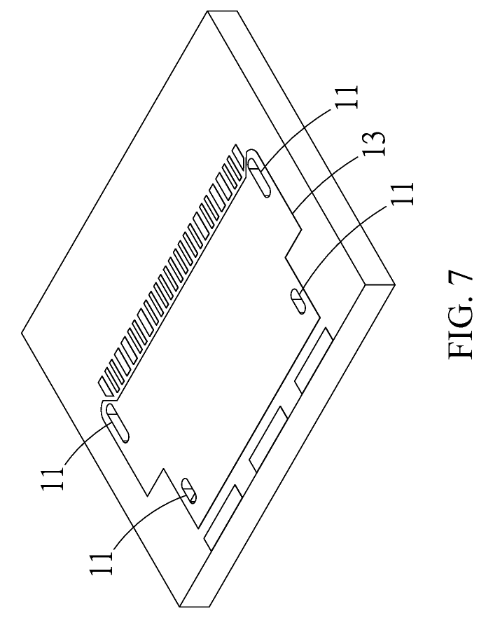

Referring to FIG. 7, in the instant embodiment, the conducting portion 13 including a single one is taken as an example, and combined with or including the conductive copper zones on the peripheries of the fixing sections 11. In other words, each of the fixing sections 11 is located inside of the conducting portion 13, so that the shielding housing of the electrical connector is set in contact with the conducting portion 13 from the insertion pins, the front section to the rear section, leaving no dead zone at all, allowing the noise draining path of the shielding housing to be maximized.

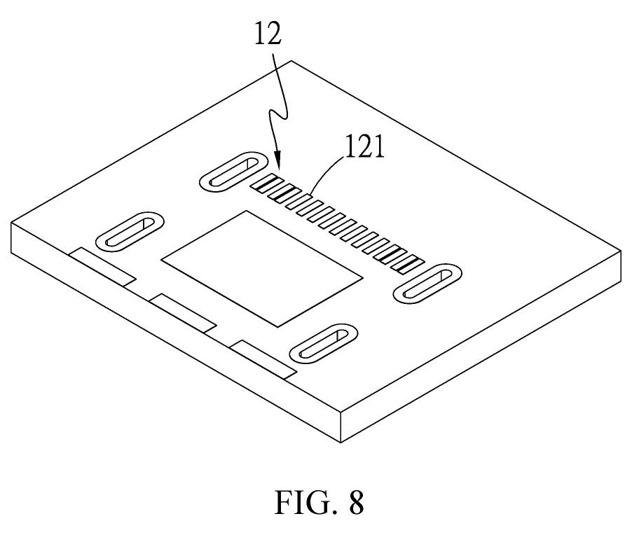

Referring to FIG. 8, the instant embodiment is different from the previous embodiments in that in the instant embodiment, the signal transmission portion 12 comprises 16 conductors 121. This shows the number of the conductors 121 is not constrained in the present invention and any number greater than 16 belongs to the scope of protection of the present invention.

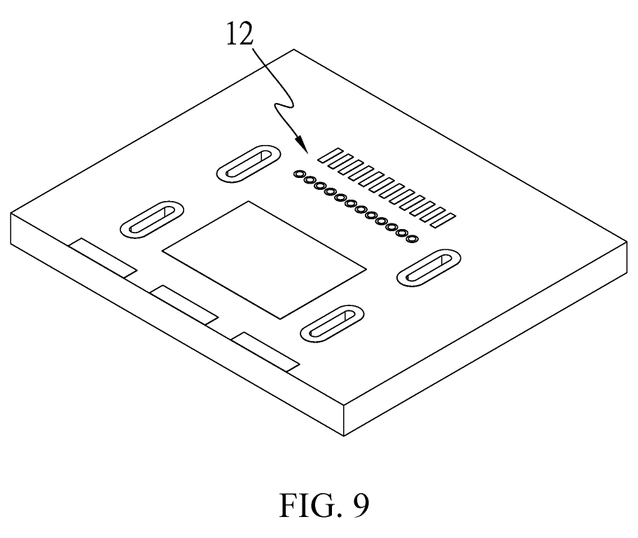

Referring to FIG. 9, the instant embodiment is different from the previous embodiments in that in the instant embodiment, the signal transmission portion 12 is arranged in dual rows, including a front one and a rear one. This shows that the arrangement of the signal transmission portion 12 is not constrained in the present invention, both single-row arrangement and dual-row arrangement belonging to the scope of protection of the present invention.

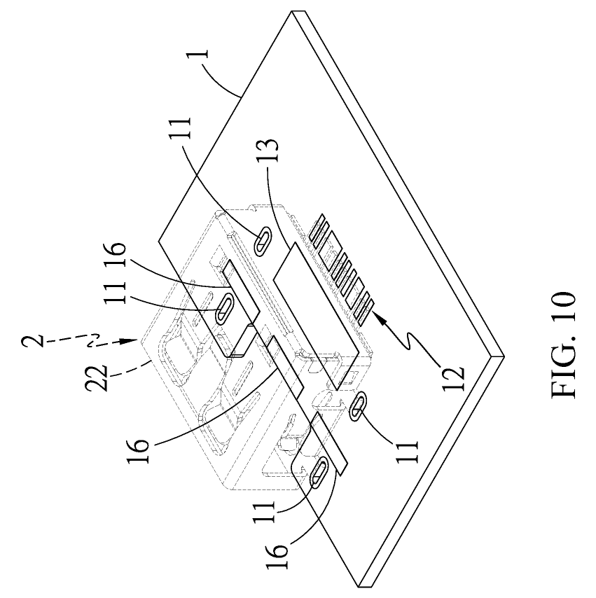

Referring to FIG. 10, the instant embodiment is different from the previous embodiments in that in the instant embodiment, a USB Type A electrical connector 2 is presented as an example, and the circuit board body 1 is similarly provided with at least one conducting portion 13 and at least one combining portion 16. As an example, the instant embodiment includes a single one conducting portion 13 and three combining portions 16, and the conducting portion 13 is located in a middle area jointly enclosed by the signal transmission portion 12 and each of the fixing sections 11, so that the bottom surface of the shielding housing 22 of the USB Type A electrical connector 2 is placed flat on and in tight contact engagement with the conducting portion 13, and thus, the entirety of the bottom surface of the shielding housing 22 can function as noise draining path to thereby provide more noise draining paths by using the enlarged grounding area.

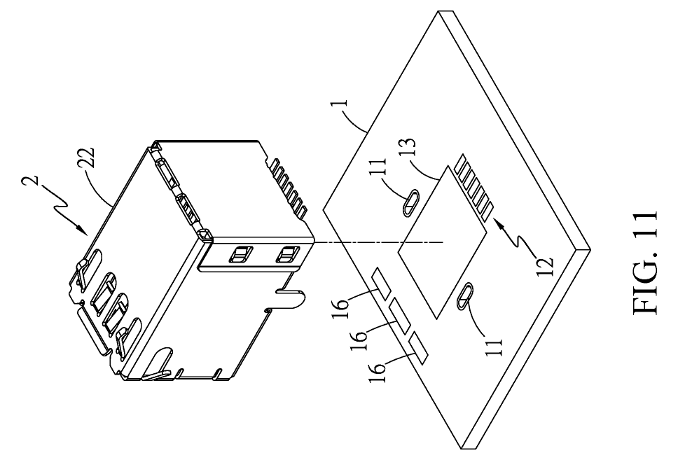

Referring to FIG. 11, the instant embodiment is different from the previous embodiments in that in the instant embodiment, a USB Type B electrical connector 2 is presented as an example, and the circuit board body 1 is provided with at least one conducting portion 13 and at least one combining portion 16. As an example, the instant embodiment includes a single one conducting portion 13 and three combining portions 16, and the conducting portion 13 is located in a middle area jointly enclosed by the signal transmission portion 12 and each of the fixing sections 11, so that t the bottom surface of the shielding housing 22 of the USB Type B electrical connector 2 is placed flat on and in tight contact engagement with the conducting portion 13, and thus, the entirety of the bottom surface of the shielding housing 22 can function as noise draining path to thereby provide more noise draining paths by using the enlarged grounding area.

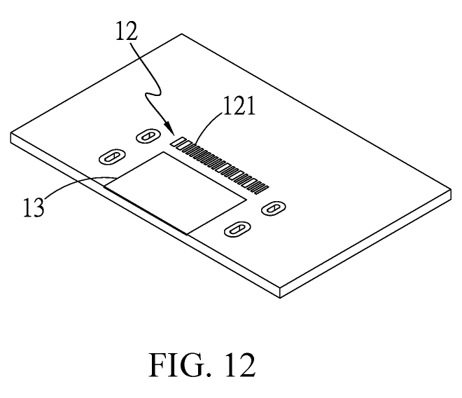

Referring to FIG. 12, in the instant embodiment, the signal transmission portion 12 that complies with High Definition Multimedia Interface (HDMI) is presented as an example, and the signal transmission portion 12 includes 21 conductors 121 that are arranged in a single row. This shows that the electrical connector can also be made for HDMI and HDMI has the characteristics of high speed transmission and is capable of transmitting uncompressed audio signals and video signals to fulfill the requirement for high image quality. Thus, during the process of signal transmission by the signal transmission portion 12, noises generated by high frequency signals can be quickly drained, and this is primarily because the arrangement of the conducting portion 13 increases the noise draining path from the shielding housing, so as to allow noises to be fast drained outside the shielding housing, and as such, the high-frequency characteristics of the transmission conductors is bettered, and electromagnetic interference (EMI) and radio frequency interference (RFI) are effectively reduced.

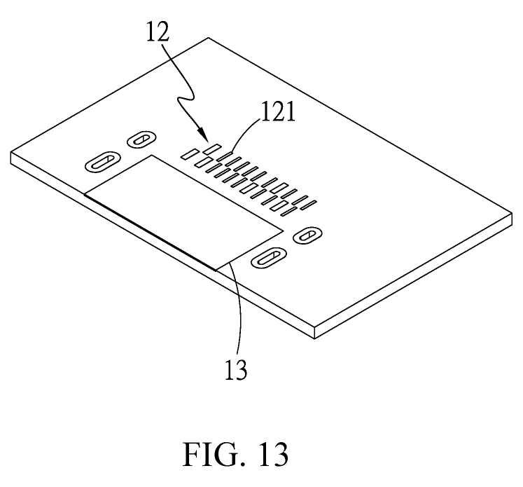

Referring to FIG. 13, in the instant embodiment, the signal transmission portion 12 that complies DisplayPort (DP) communication transmission protocol is presented as an example, and the signal transmission portion 12 includes 22 conductors 121 that are arranged as dual rows including a front one and a rear one. In this, DP also belons to an electrical connector capable of high speed transmission, and the noise interference generated thereby can also quickly drained outside of the shielding housing by means of the conducting portion 13, and as such, the high-frequency characteristics of the transmission conductors is bettered, and electromagnetic interference (EMI) and radio frequency interference (RFI) are effectively reduced.

Thus, the key technique of the present invention is as follows:

The combining portion 16 is used to fix the electrical connector 2 in position, so as to make the opening 223 of the shielding housing 22 firmly fixed, without causing separation between the insertion pins 21 and the circuit board body 11, and deformation or breaking of the bridging and connecting structure between the front section 221 and the rear section 222 of the shielding housing 22.

The arrangement of the conducting portion 13 helps improve the capability of noise draining and effectively reduces electromagnetic interference (EMI) and radio frequency interference (RFI) and also betters the high-frequency characteristics.

The arrangement of the insulation region 14 allows the conducting portion 13, even under a condition of being minimized, to achieve a better noise draining performance than known electrical connectors.

The single row arrangement of the signal transmission portion 12 allows engineering and operation of combination of the soldering portion of the electrical connector 2 with the signal transmission portion 12 to be carried out in a more convenient and faster way.

In case that the fixing sections 11 are arranged inside of the conducting portion 13, the conducting portion 13 is maximized, and this implies that more noise draining paths are fulfilled to thereby make draining of noise faster and achieve better high-frequency transmission characteristics.

I claim:

1. A circuit board structure of an electrical connector, comprising:
a circuit board body;
a plurality of fixing sections, which are arranged on the circuit board body for receiving insertion of insertion pins of an electrical connector therein;
a signal transmission portion, which complies a communication transmission protocol of one of USB-A, USB-B, USB-C, HDMI, and DP and is arranged on the circuit board body and located at one side of each of the fixing sections for receiving soldering portions of the electrical connector to combine therewith by means of surface mount technology (SMT);
at least one conducting portion, which is arranged in an area jointly enclosed by the signal transmission portion and each of the fixing sections for receiving a bottom surface of the electrical connector to contact therewith in order to conduct out and drain noises; and
at least one combining portion, which is arranged on the conducting portion or at one side of the conducting portion for connecting and fixing the circuit board body to the bottom surface of the electrical connector.

2. The circuit board structure of the electrical connector according to claim 1, wherein the conducting portion and the combining portion comprise conductive copper materials.

3. The circuit board structure of the electrical connector according to claim 1, wherein the conducting portion is arranged between each of the fixing sections.

4. The circuit board structure of the electrical connector according to claim 1, wherein an insulation region is arranged between the conducting portion and the signal transmission portion and each of the fixing sections.

5. The circuit board structure of the electrical connector according to claim 1, wherein the electrical connector is USB-C, and the signal transmission portion comprises at least 16 conductors.

6. The circuit board structure of the electrical connector according to claim 1, wherein the signal transmission portion is arranged in a single row.

7. The circuit board structure of the electrical connector according to claim 1, wherein the signal transmission portion is arranged in dual rows including a front row and a rear row.

8. The circuit board structure of the electrical connector according to claim 1, wherein the conducting portion comprises a single one, and each of the fixing sections is located inside of the conducting portion.

9. The circuit board structure of the electrical connector according to claim 1, wherein the electrical connector is HDMI or DP, and the signal transmission portion comprises at least 20 conductors arranged in a single row.

10. The circuit board structure of the electrical connector according to claim 1, wherein the electrical connector is HDMI or DP, and the signal transmission portion comprises at least 20 conductors arranged in dual rows.
